(19) United States
(12) Patent Application Publication
(10) Pub. No.: US 2008/0165251 A1
(43) Pub. Date: Jul. 10, 2008

(54) CAMERA SYSTEMS AND METHODS FOR CAPTURING IMAGES IN MOTOR VEHICLES

(76) Inventor: David McScott O'Kere, McDonough, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/849,553

(22) Filed: Sep. 4, 2007

Related U.S. Application Data
(60) Provisional application No. 60/878,546, filed on Jan. 4, 2007.

(51) Int. Cl. H04N 7/18

(52) U.S. Cl. 348/148

(57) ABSTRACT

Various embodiments of camera systems for capturing images in motor vehicles and methods related to such systems are disclosed. One embodiment, among others, comprises a camera system in a motor vehicle, comprising a camera configured to obtain an image of an occupant of the motor vehicle; a controller configured to obtain image data from the camera in response to an activation signal; memory configured to store the image data; and a preservation enclosure configured to receive the controller and the memory.

### CROSS-REFERENCE TO RELATED APPLICATION

This application claims priority to copending U.S. provisional application entitled, “CAMERA SYSTEMS AND METHODS FOR CAPTURING IMAGES IN MOTOR VEHICLES” having Ser. No. 60/878,546, filed Jan. 4, 2007, which is entirely incorporated herein by reference.

### FIELD OF THE INVENTION

The present disclosure generally relates to the field of camera systems and, in particular, to camera systems in motor vehicles.

### BACKGROUND

Motor vehicles are frequently the target of theft because of their high value and utility. Such thefts occur in many fashions, the most dangerous of which is carjackings. A carjacking occurs when a thief approaches the owner of an automobile and threatens them if they do not turn over their vehicle. Carjackers frequently abduct the vehicle owner and occupants along with the vehicle. In many of these incidents, the vehicle owner and occupant are injured, and even sometimes killed.

Automobile security devices have been offered but have not generally had a significant impact on theft, especially on carjackings and the subsequent investigation. Traditional security devices such as car alarms operate by securing the vehicle against physical break-ins but this does not help the owner of a vehicle who has a gun pointed at them. In such a scenario, traditional security systems simply do not offer any protection.

### SUMMARY

Embodiments of the present disclosure provide camera systems for capturing images in motor vehicles and methods related to such systems.

Briefly described, one embodiment, among others, comprises a camera system in a motor vehicle, comprising a camera configured to obtain an image of an occupant of the motor vehicle; a controller configured to obtain image data from the camera in response to an activation signal; memory configured to store the image data; and a preservation enclosure configured to receive the controller and the memory. Another embodiment, among others, comprises a camera system, comprising means for acquiring image data of an occupant of the motor vehicle in response to an activation signal; and means for storing the image data. Another embodiment, among others, comprises a method for capturing images in a motor vehicle, comprising obtaining image data of an occupant of the motor vehicle in response to an activation signal; and storing the image data in memory.

Other systems, apparatus, methods, features, and advantages of the present disclosure will be or become apparent to one with skill in the art upon examination of the following drawings and detailed description. It is intended that all such additional systems, apparatus, methods, features, and advantages be included within this description, be within the scope of the present disclosure, and be protected by the accompanying claims.

### BRIEF DESCRIPTION OF FIGURES

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of an embodiment of a camera system for capturing images in a motor vehicle.

FIG. 2 is a flow diagram illustrating a method for operating the camera system of FIG. 1.

FIG. 3 is a flow diagram illustrating a method for downloading stored image data from the camera system of FIG. 1.

FIG. 4 is a schematic diagram of another embodiment of the camera system of FIG. 1 including a plurality of cameras.

### DETAILED DESCRIPTION OF THE PREFERRED EMBODIMENTS

Disclosed herein are various embodiments of camera systems for capturing images in motor vehicles and methods related to such systems. Reference will now be made in detail to the description of the embodiments as illustrated in the drawings, wherein like reference numbers indicate like parts throughout the several views.

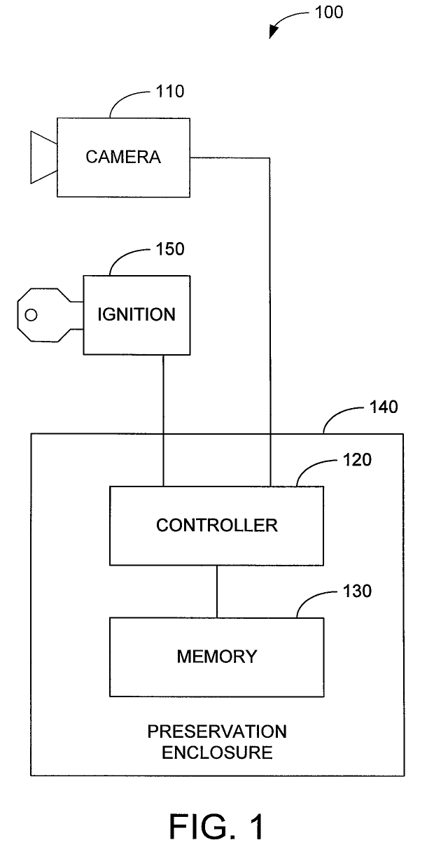

FIG. 1 is a schematic diagram of an embodiment of a camera system 100 for capturing images in a motor vehicle. Motor vehicles can include, but are not limited to, cars, trucks, buses, boats, and motorcycles. In FIG. 1, camera system 100 includes a camera 110, a controller 120, memory 130, and a preservation enclosure 140.

Camera 110 is mounted in the motor vehicle. In one embodiment, camera 110 is mounted on the dashboard of the motor vehicle to obtain images of a person sitting in the driver's seat of the motor vehicle. Camera 110 may also be configured to capture images of all occupants in the vehicle. Miniaturization may also allow integration of camera 110 into the dashboard to avoid discovery. In other embodiments, camera 110 may be mounted and/or integrated at different locations in the motor vehicle, such as, but not limited to, a steering wheel, roof, floor, doors, seats, window visors, and rearview mirrors. The camera 110 may also be positioned to obtain images of other areas within the motor vehicle. Camera 110 may be analog or digital and can include zoom, night vision, and infrared capabilities.

The controller 120 and memory 130 are located within a preservation enclosure 140. The preservation enclosure 140 protects the enclosed components from the adverse effects of heat, moisture, shock, impact, and weather similar to a black box in aircraft. If the vehicle is stripped of components, damaged in an accident, and/or burnt, the preservation enclosure 140 protects the enclosed components (e.g., controller 120 and memory 130) for subsequent retrieval of data and/or information stored on the components. The preservation enclosure 140 may be mounted at various locations in the motor vehicle, such as, but not limited to, under the dashboard, under a seat, in the trunk, and/or in the engine compartment. In other embodiments, the preservation enclosure 140 may be integrated into components of the motor vehicle, such as, but not limited to, the steering column, the ignition box, the engine block, the fire wall, and/or the vehicle frame.

The controller 120 disclosed herein can be implemented in software, hardware, or a combination thereof. In some embodiments, the system and/or method is implemented in controller software that is stored in a memory and that is executed by a suitable processor situated in a computing device. However, the systems and methods can be embodied in any computer-readable medium for use by or in connection with an instruction execution system, apparatus, or device. Such instruction execution systems include any computer-based system, processor-containing system, or other system that can fetch and execute the instructions from the instruction execution system. In other embodiments, the controller 120 is implemented in hardware, including, but not limited to, a programmable logic device (PLD), programmable gate array (PGA), field programmable gate array (FPGA) or an application-specific integrated circuit (ASIC). Examples of controllers that can be implemented in the controller 130 are discussed in “IN-CAR DIGITAL VIDEO RECORDING WITH MPEG-4 COMPRESSION FOR POLICE CRUISERS AND OTHER VEHICLES,” U.S. Pat. No. 7,190,882, and “SURVEILLANCE SYSTEM AND IMAGE SIGNAL PROCESSING APPARATUS,” U.S. Pat. No. 7,236,522, which are both entirely incorporated herein by reference. One skilled in the art would understand that other methods of control could be used to obtain, process, and store analog or digital image data.

The controller 120 is configured to obtain image data from camera 110 and store the data in memory 130 for later retrieval. Controller 120 may obtain image data from camera 110 using a wired connection and/or a wireless connection, such as, but not limited to, infrared (IR), radio frequency (RF), WiFi, WiMax, Ultra-Wide Band (UWB), Bluetooth, or other suitable communication technologies. Images may be recorded individually or as a series of images. Recording speed (e.g., frames per second) can be a preset value or may be determined and/or varied by the controller 120. Factors that can affect recording speed include, but are not limited to, image resolution, connection transfer capabilities, controller processing speed, and available memory. The length of the recording may be a predetermined time period or number of images (or frames). Controller 120 may also be able to vary recording length based on the same or different factors affecting recording speed.

The memory 130 can comprise a combination of volatile and/or non-volatile memory components. For instance, the memory 130 can comprise one or more random access memory (RAM), read-only memory (ROM), static dynamic random access memory (SDRAM), and hard drive components. In addition, the memory 130 can comprise read-only memory (e.g., Flash memory) and one or more removable memory components, such as, but not limited to, a pen drive, a flash drive, a memory stick, a memory card, or hard disk card.

Controller 120 may store image data in memory 130 using a standard format including, but not limited to, JPEG, TIFF, and RAW, or image compression including, but not limited to, wavelet, MPEG-4, GIF, and PGF. Controller 120 can store image data in memory 130 in a sequential manner or using file organization (e.g., directory) similar to that used in Windows. In one embodiment, the memory 130 is a fixed size sufficiently large to store all images recorded during a predetermined period of time, such as, but not limited to, one year, six months, or one month. In other embodiments, the memory 130 may be expandable. Controller 120 may also use volatile memory (e.g., RAM, SDRAM) to initially store image data from camera 110 during the recording period and subsequently transfer the stored image data to a hard drive and/or removable memory component after the recording has been completed.

In one embodiment, once all available memory 130 has been used to store the image data, controller 120 records new image data over previously stored data such that the oldest image data is written over first. In another embodiment, the controller 120 can indicate to an operator of the vehicle, using visual and/or audio means (e.g., warning light, beeping), that only a limited amount of memory remains available for recording (e.g., less than ten percent, less than 5 MB, less than two recording periods). The operator (and/or owner) of the motor vehicle can then have the camera system 100 serviced to download and/or delete the image data stored in memory 130 or remove memory components containing stored image data and replace with memory components containing no data.

The controller 120 and memory 130 can be accessed by removing the preservation enclosure 140 from the motor vehicle. In one embodiment, the preservation enclosure 140 must be opened to access the stored image data. Access to the memory 130 allows for removal of existing memory components and replacement with memory components having no stored data. The image data on the removed memory components can be subsequently accessed to download and/or delete the stored data without additional access to the camera system 100. In alternate embodiments, placement of the preservation enclosure 140 may allow access without removal.

Stored image data may also be downloaded and/or deleted without removal of the memory 130. An input/output (I/O) port can provide access to the controller 120 and memory 130 through a wired connection and allow downloading and/or deleting the stored image data. The camera system 100 can be configured to allow internal access to the I/O port (i.e., after opening the preservation enclosure 140). Alternatively, the camera system 100 may be configured to allow external access to the I/O port without removal and/or opening the preservation enclosure 140. In other embodiments, access to the controller 120 and memory 130 may be provided by a wireless connection, such as, but not limited to, infrared (IR), radio frequency (RF), WiFi, WiMax, Ultra-Wide Band (UWB), Bluetooth, mobile telephone or other suitable communication technologies.

Downloading and/or deleting stored image data can be accomplished using a portable hand-held device designed to interface with controller 120 and memory 130 or with a computer, connected either directly or indirectly through a network, with a program designed to allow interfacing with controller 120 and memory 130. The controller 120 downloads (or transfers) the stored image data to the hand-held device or computer and/or deletes the stored image data in memory 130 based upon instructions received from the hand-held device or computer program. The downloaded (or transferred) image data may be subsequently displayed, stored, or transferred by the hand-held device or computer.

In an alternate embodiment, the camera system 100 can be configured to provide access to the controller 120 and the image data in memory 130 without physical access to the motor vehicle. Mobile telephone technology can allow remote access of the camera system 100 while the vehicle is in motion. A remotely located computer can access the controller 120 and memory 130 by connecting through the mobile telephone network. The controller 120 can be configured to transmit real-time and stored image data as well as download and/or delete stored image data, as discussed previously. This can provide real-time information to law enforcement personnel. The computer may also utilize an Internet and/or other network connection to access the mobile telephone network for connecting with camera system 100. In addition, the camera system 100 may be accessed by and/or integrated into a vehicle's communication, monitoring and tracking service such as, but not limited to, OnStar.

In the embodiment illustrated in FIG. 1, the camera system 100 is initiated by the motor vehicle's ignition switch 150. Alternatively, image data acquisition by the camera system 100 could be initiated by other portions of the motor vehicle's ignition system. In other embodiments, image data acquisition may be initiated by shifting to drive or reverse after being in park for a preset period of time (e.g., 3 seconds). This would cause the controller 120 to obtain image data in the situation where someone was forced to exist the vehicle while it was running or where the vehicle was left running while unattended.

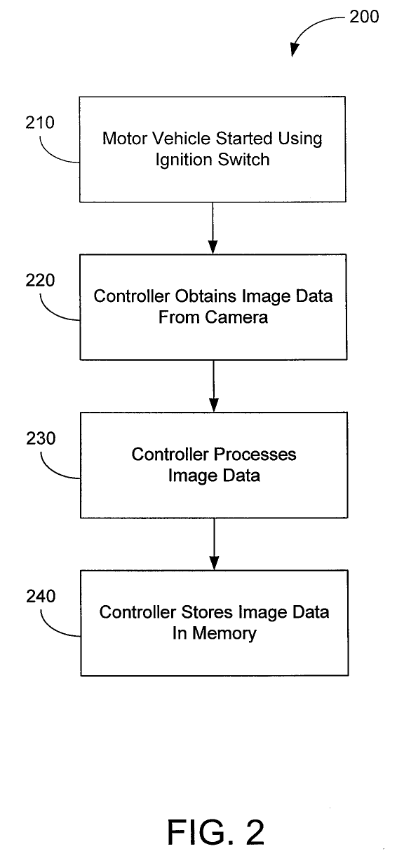

FIG. 2 is a flow diagram 200 illustrating a method for operating the camera system 100 of FIG. 1. To begin, in box 210 the motor vehicle is started using the ignition switch 150. In box 220, controller 120 obtains image data in response to starting with the ignition switch 150. In a preferred embodiment, controller 120 obtains 5 minutes of image data. As discussed previously, recording for other time periods or number of images may be implemented.

Controller 120 processes the image data in box 230. Processing can include, but is not limited to, reformatting and/or compressing the image data for storage. Processing may also include real-time transmission of the image data to a remotely located computer. The controller 120 stores the image data in memory 130 in box 240. One skilled in the art would understand that processing of the image data (box 230) may not be necessary for storage of the image data (box 240) and may be eliminated from the flow diagram 200.

In addition, it would be understood by one skilled in the art that the operations of boxes 220, 230, and 240 may be carried out sequentially or in parallel. Moreover, the ordering of the boxes may be changed. For example, the controller 120 may obtain the image data (box 220) and immediately store the data in memory 130 (box 240) prior to processing (box 230). After recording is complete, the controller 120 can subsequently obtain the stored image data from memory 130, process the data (box 240), and store the processed image data back in memory. The original image data may then be retained or deleted as desired. One skilled in the art would understand that other methods and procedures may be utilized to obtain and store the image data.

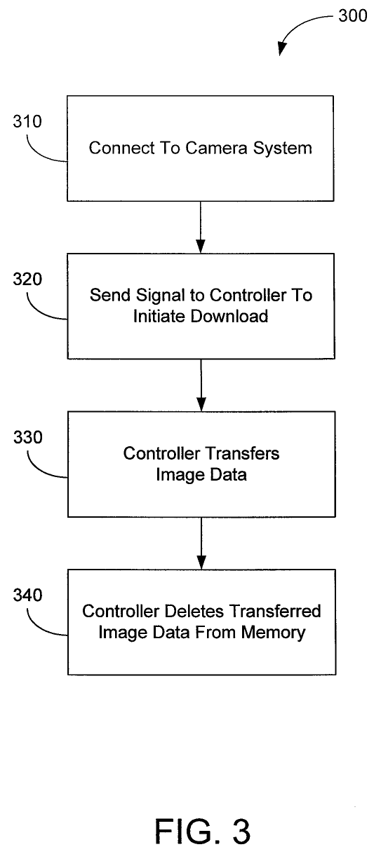

FIG. 3 is a flow diagram illustrating a method for downloading stored image data from the camera system of FIG. 1. To begin, in box 310 a portable hand-held device or computer is connected to the camera system 100. This can be through a wired connection using an I/O port, as discussed previously, or through a wireless connection. Once the connection has established, the portable hand-held device or computer can send a signal to the controller 120 to initiate download (box 320) of the stored image data. Upon receipt of the appropriate signal, in box 330 the controller 120 transfers the stored image data to the portable hand-held device or computer. Once the transfer is complete, the controller 120 deletes the transferred stored image data to free up space in memory 130 for storage of new image data. Alternatively, a second signal sent by the portable hand-held device or computer may be required to initiate deletion of the transferred data.

One skilled in the art would understand that other methods and procedures may be utilized to retrieve and/or delete the stored image data. Controller 120 may be able to transmit individual images (or frames) for viewing on the portable hand-held device or computer. Additionally, controller may be able to delete stored image data without first downloading based upon receipt of a signal from the portable hand-held device or computer. Deletion of stored image data may also be carried out automatically based upon a preset time limit (e.g., daily deletion of image data that has been stored for more than one year).

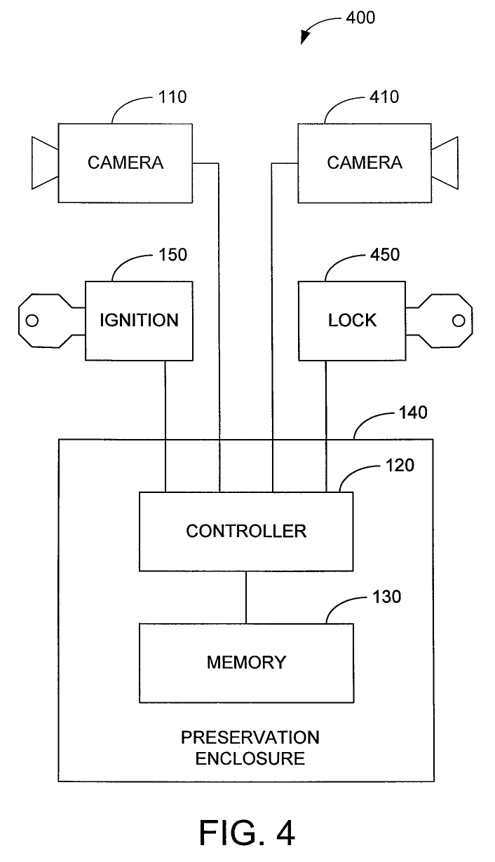

FIG. 4 is a schematic diagram of another embodiment of the camera system of FIG. 1 including a plurality of cameras. In this embodiment, camera system 400 includes camera 410 in addition to the camera 110, controller 120, memory 130, and preservation enclosure 140 in FIG. 1.

Camera 410 is mounted in the trunk of the motor vehicle to obtain images of a person opening the trunk. Camera 110 may be mounted and/or integrated at different locations in the motor vehicle, such as, but not limited to, seat backs, trunk lid, side walls, floor, and trunk light. The camera 410 may also be positioned to obtain images of other areas within the trunk of the motor vehicle. Camera 410 may be analog or digital and can include zoom, night vision, and infrared capabilities.

In addition to the features described in relation to FIG. 1, controller 120 is configured to obtain image data from camera 410 and store the data in memory 130 for later retrieval. Controller 120 may obtain image data from camera 410 using a wired connection and/or a wireless connection. As in the embodiment illustrated in FIG. 1, image data acquisition from camera 110 is initiated by the motor vehicle's ignition switch 150. In contrast, image data acquisition from camera 410 is initiated when the trunk lock 450 is opened. Alternatively, a switch indicating that the trunk lid is opened may also cause the controller 120 to obtain image data from camera 410. In another embodiment, a pushbutton switch located in the trunk allows someone trapped in the trunk to initiate image data acquisition.

Image data is obtained from camera 410 and stored in memory 130 in the same manner as described for camera 110. Acquisition of image data from cameras 110 and 410 can be carried out in parallel, in series or separately. Also, image data may be obtained from cameras, 110 and 140, in a staggered fashion (e.g., image data for one frame from camera 110 followed by image data for one frame from camera 410). One skilled in the art would understand that other methods can be utilized to obtain image data from a plurality of cameras.

In other embodiments, camera 410 can be mounted inside or outside of the motor vehicle to obtain images of a person opening a car door. Camera 110 may be mounted and/or integrated at different locations in the motor vehicle, such as, but not limited to, a side mirrors, door frames, and seats. In these embodiments, image data acquisition from camera 410 can be initiated when a door lock 450 is opened or alternatively, when a switch indicates that the door is open.

Other embodiments may include a plurality of cameras with the controller 120 configured to obtain image data from each camera. Image data can be obtained from each individual camera with an associated activation signal is received by the controller 120. Alternatively, upon receipt of a common activation signal, the controller 120 can obtain image data from multiple cameras.

In addition to image data, audio data can also be acquired by integrating microphones (not shown) into the embodiments of the camera systems presented previously. Audio data can be obtained and stored by the controller 120 simultaneously with the image data. One skilled in the art would understand methods for integrating audio data acquisition into the current embodiments.

With the inclusion of microphones, the camera system 100 or 400 can include a voice activation system (not shown) to initiate image and/or audio data acquisition. The voice activation system is configured to recognize a trigger (or activation) phrase. Recognition of the phrase can cause the camera system to obtain and store image data in the same manner described in FIG. 2 for ignition switch initiation. Examples of voice activation systems that can be implemented in the handle assembly 150 are discussed in “VOICE RECOGNITION PERIPHERAL DEVICE,” U.S. Pat. No. 6,952,676, and “SYSTEM AND METHOD FOR TELEPHONIC SWITCHING AND SIGNALING BASED ON VOICE RECOGNITION,” U.S. Pat. No. 6,999,564, which are both entirely incorporated herein by reference. One skilled in the art would understand that other methods of activation could be used to initiate acquisition of image and/or audio data.

Time stamp and location data can also be included in the image and/or audio data stored in memory 130. In other embodiments, global positioning system (GPS) electronics can be included in the preservation enclosure 140 to provide location information to the controller for inclusion in the stored data.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of without departing substantially from the spirit and principles of the disclosure. All such modifications and variations are intended to be included herein within the scope of this disclosure.

At least the following is claimed:

1. A camera system in a motor vehicle, comprising:
a camera configured to obtain an image of an occupant of the motor vehicle;
a controller configured to obtain image data from the camera in response to an activation signal;
memory configured to store the image data; and
an enclosure configured to protect the controller and the memory.

2. The system of claim 1, wherein the activation signal is generated in response to starting the motor vehicle.

3. The system of claim 1, wherein the activation signal is generated in response to shifting the motor vehicle transmission out of a park position.

4. The system of claim 3, wherein the transmission was in the park position for a predetermined period prior to shifting.

5. The system of claim 1, wherein the camera is configured to obtain an image of all occupants of a passenger compartment of the motor vehicle.

6. The system of claim 1, wherein the camera is a digital camera.

7. The system of claim 1, wherein the controller is further configured to process the image data.

8. The system of claim 7, wherein processing the image data includes image compression.

9. The system of claim 1, further comprising an input/output (I/O) port to access the controller and memory.

10. The system of claim 9, wherein the I/O port is accessible from the exterior of the preservation enclosure.

11. The system of claim 1, further comprising a wireless connection to access the controller and memory.

12. The system of claim 1, further comprising.
a second camera configured to obtain an image of a person opening the trunk of the motor vehicle; and
the controller configured to obtain image data from the second camera in response to a second activation signal.

13. The system of claim 12, wherein the second activation signal is generated in response to opening the trunk of the motor vehicle.

14. A camera system in a motor vehicle, comprising:
means for acquiring image data of an occupant of the motor vehicle in response to an activation signal; and
means for storing the image data.

15. The system of claim 14, further comprising means for processing the acquired image data.

16. The system of claim 14, further comprising means for accessing the stored image data.

17. The system of claim 14, further comprising means for acquiring image data of a person accessing an interior compartment of the motor vehicle in response to a second activation signal.

18. The system of claim 14, further comprising:
means for acquiring audio data of the occupant in response to the activation signal; and
means for storing the audio data.

19. The system of claim 14, further comprising means for generating an activation signal by voice recognition.

20. A method for capturing images in a motor vehicle, comprising:
obtaining image data of an occupant of the motor vehicle in response to an activation signal; and
storing the image data in memory.
